(19) United States
(12) Patent Application Publication
(10) Pub. No.: US 2002/0177353 A1
(43) Pub. Date: Nov. 28, 2002

(54) Hot line clamp

(75) Inventor: Robert De France, Poughkeepsie, NY (US)

Correspondence Address: ALIX YALE & RISTAS LLP, 750 MAIN STREET, SUITE 1400, HARTFORD, CT, 06103, US

(73) Assignee: DELRI LLC

(21) Appl. No.: 09/738,654

(22) Filed: Dec. 15, 2000

(51) Int. Cl. H01R 13/00

(52) U.S. Cl. 439/477

(57) ABSTRACT

A hot line clamp for attachment to an associated electrical distribution line comprises a first body that has a first body that has a first jaw and a second body that has a second jaw. One of the first and second bodies has a screw thread disposed therein. An eyebolt is dimensioned and configured for engaging the screw thread. The eyebolt has surfaces engaging the other of the bodies to force the other of the bodies toward the one of the first and second bodies to cause the first and second jaws to clamp on an associated line conductor. One of the bodies further includes a first mounting pad for mounting at least one adapter for making an additional connection to the hot line clamp. In some forms of the invention, the first mounting pad includes non-planar surfaces to increase the contact area and to provide locking engagement.

### BACKGROUND OF THE INVENTION

1. Field of the Invention

The present invention relates to the field of electric power transmission and, more particularly, to a connector or clamp that includes various modular accessories for attaching a tap conductor to a line or run conductor. Such line or run conductors are often overhead power distribution conductors carried on utility poles.

2. Description of the Prior Art

Single purpose clamps or connectors that provide a single structure for attaching a tap conductor to a line or run conductor are well known in the art. The usual and customary practice in the field is to provide a unique hot line clamp to achieve any one of various possible connections to a run or line conductor. In other words, each hot line clamp intended for any of various applications must be specifically engineered for that specific application. In accordance with this practice, specific hot line clamps are provided for a tap conductor, a stud adapter, a compression adapter, a tapbolt adapter, or other accessory. Typical known hot line clamps are not multipurpose devices.

Accordingly, designing clamps for special applications requires an entirely new device. This concept results in the manufacture of a wide variety of clamps which are each designed for special applications. This specific feature characteristically tends to adversely impact the market for such products. More specifically, the manufacture of a number of different clamps or connectors means that each individual clamp connector does not achieve the maximum economies of scale. Accordingly, the manufacture of a number of different kinds of clamps or connectors limits the market for any such given connector. In addition, the consumer must stock a variety of specialized clamps for future installation requirements. Thus, the custom of manufacturing a number of unique assemblies tends to result in greater expense to manufacture each unique assembly and greater expense to maintain an inventory of each of the unique assemblies in the marketing distribution channels, as well as greater expense to maintain an inventory of each of the unique assemblies at the facilities of the consumer of this product.

### SUMMARY THE INVENTION

An object of the present invention is to provide a hot line clamp that is adaptable for a variety of applications without the need for individually designing clamps for specific applications.

Another object of the invention is to provide a modular hot line clamp that will benefit from the economies of scale in the manufacturing process and which will reduce the expense involved in maintaining an adequate inventory and marketing distribution channels.

Still another object of the invention is to provide apparatus that is relatively easy to manufacture and that can be manufactured at moderate expense.

It has now been found that these and other objects of the invention may be attained in a hot line clamp for attachment to an associated electrical distribution line which comprises a first body that has a first jaw and a second body that has a second jaw. One of the first and second bodies has screw threads disposed therein. An eyebolt is dimensioned and configured for engaging the screw threads. The eyebolt has surfaces engaging the other of the bodies to force the other of the bodies toward the one of the first and second bodies to cause the first and second jaws to close on an associated line conductor. One of the first and second bodies further includes a first mounting pad for mounting at least one adapter for making an additional connection to the hot line clamp.

In some forms of the invention, the first mounting pad includes non-planar surfaces to increase the contact area and to provide locking engagement. The hot line clamp may have a first mounting pad that is circular and includes a plurality of radially extending ridges. The hot line clamp may include a modular accessory. The modular accessory may include a second mounting pad that is identical to the first mounting pad. In some forms of the invention, the hot line clamp has first and second mounting pads that provide locking engagement therebetween at any of a plurality of relative angular positions.

The hot line clamp may include a first mounting pad that includes a plurality of radially extending ridges. In some forms of the hot line clamp, a plurality of radially extending ridges are disposed at equal angular intervals about the first mounting pad. The hot line clamp may include a modular accessory which may include a second mounting pad that is identical to the first mounting pad. The first and second mounting pads are dimensioned and configured for meshing engagement therebetween. The hot line clamp may include a first mounting pad which includes a plurality of radially extending ridges that are substantially uniformly disposed about the entire extent of the mounting pad.

Some forms of the hot line clamp further include an accessory having a second mounting pad dimensioned configured for engagement with the first mounting pad.

### BRIEF DESCRIPTION OF THE DRAWING

The invention will be better understood by reference to the accompanying drawing in which:

FIG. 1 is a partially sectional, partially schematic side view of a preferred embodiment in accordance with one form of the present invention and which illustrates the jaws thereof positioned to provide the maximum possible opening.

FIG. 2 is a partially sectional, partially schematic side view of the apparatus illustrated in FIG. 1 and which illustrates the jaws thereof positioned in engagement with a line or run conductor.

FIG. 3 is a partially sectional, partially schematic side view of the apparatus illustrated in FIGS. 1 and 2 and which illustrates the jaws thereof positioned in abutting relationship without a conductor intermediate the jaws.

FIG. 4 is a partially sectional, partially schematic front view of the apparatus illustrated in FIGS. 1, 2, and 3.

FIGS. 5 and 6 are respectively side and front views of a modular threaded stud adapter for use with the apparatus illustrated in FIGS. 1-4.

FIGS. 7 and 8 are respectively side and front views of a modular compression adapter for use with the apparatus illustrated in FIGS. 1-4.

FIGS. 9 and 10 are respectively side and front views of a modular stud adapter for use with the apparatus illustrated in FIGS. 1-4.

FIGS. 11 and 12 are respectively front and side views of a modular tapbolt connector adapter for use with the apparatus illustrated in FIGS. 1-4.

FIGS. 13 and 14 are respectively front and side views of a modular two-hole spade connector adapter for use with the apparatus illustrated in FIGS. 1-4.

FIG. 15 is an exploded view of a similar embodiment of the present invention.

### DETAILED DESCRIPTION OF THE PREFERRED EMBODIMENT

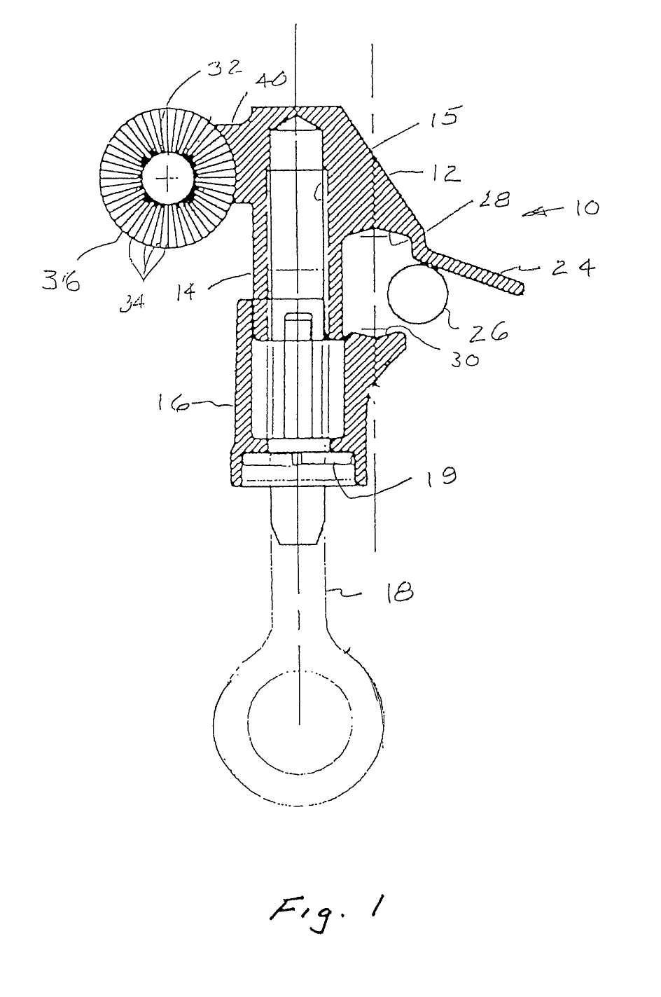

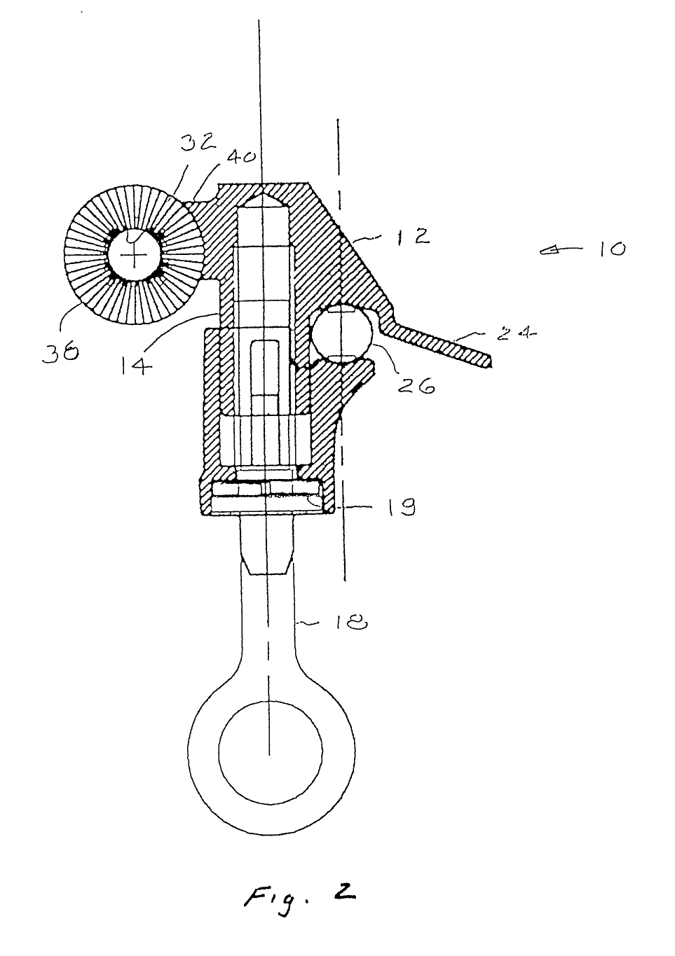

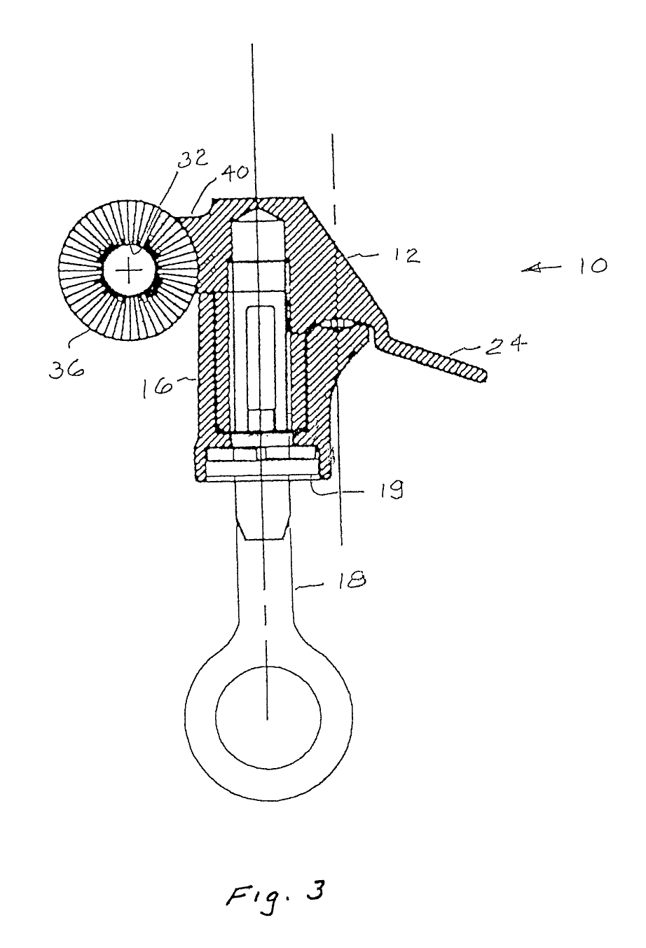

Referring now to FIGS. 1-4, there is shown a hot line connector 10 in accordance with a preferred form of the present invention. The connector 10 includes a main body 12 having an elongated lower extremity 14. A barrel 16 surrounds the elongated lower extremity 14. The elongated lower extremity 14 has a threaded internal bore 15 extending in generally coaxial relationship with the elongated lower extremity 14.

A threaded eyebolt 18 cooperates with the threaded internal bore 15. A utility worker will use a so-called hot stick to rotate the eyebolt 18 in order to cause engagement with a line conductor 26. The eyebolt 18 includes a flange 19 that is disposed in generally abutting relationship to the lower (as viewed) axial extremity of the barrel 16. Thus, as the eyebolt 18 is rotated clockwise (in the case of a right-hand thread), the eyebolt 18 will move upward (as viewed) causing the barrel 16 to move upward because of flange 19 abutting the barrel 16. More specifically, the jaw 30 carried on the barrel 16 will move toward the jaw 28 disposed on the main body 12. The utility worker will ordinarily move the duck bill 24 extension to locate and engage the line conductor 26 generally intermediate the upper jaw 30 that is part of the main body 12 and the lower jaw 28 that is part of the barrel 16.

The apparatus in accordance with the present invention makes possible the use of a range of modular connections to the clamp by means of a mounting pad 36 having a central bore 32. The bore 32 is dimensioned and configured for engagement with an associated nut and bolt (not shown) that will fix an accessory device to the mounting pad 36. The mounting pad 36 is provided with a plurality of radially extending ridges 34 disposed substantially uniformly around the entire 360 degree extent thereof. Advantageously the jaws 28, 34 are disposed on a side of the clamp 10 opposite to the side thereof on which the mounting pad 36 is mounted on an arm 40. This is desirable to avoid any possible contact between the line conductor 26 and any conductor that may be attached by any one of the various modular connectors to the mounting pad 36. This is particularly significant if the respective conductors are manufactured of different metals, such as aluminum and copper, and thus might be vulnerable to corrosion because they are different metals.

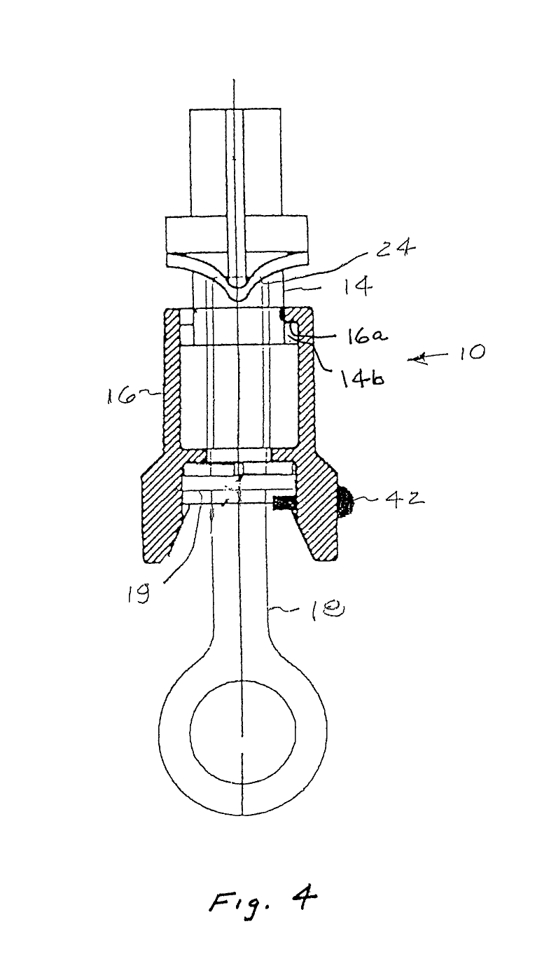

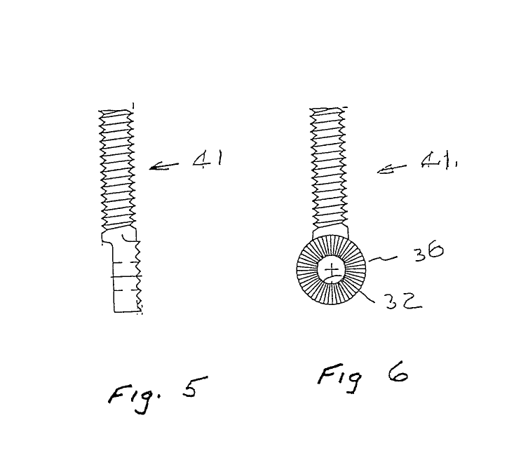

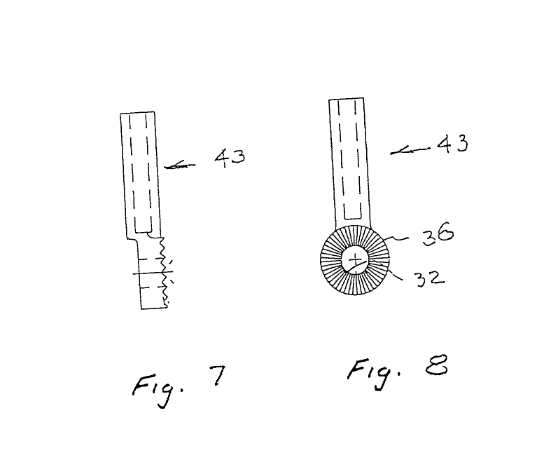

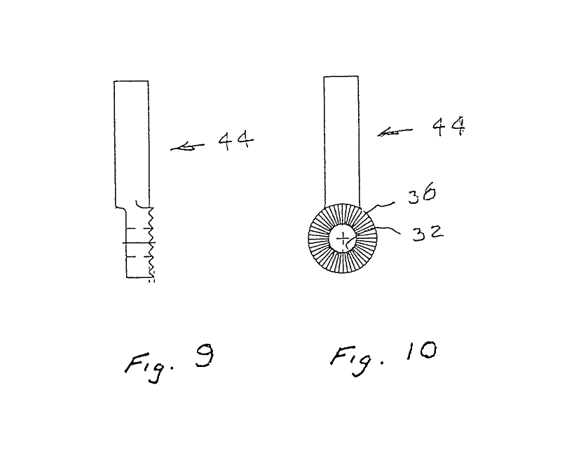

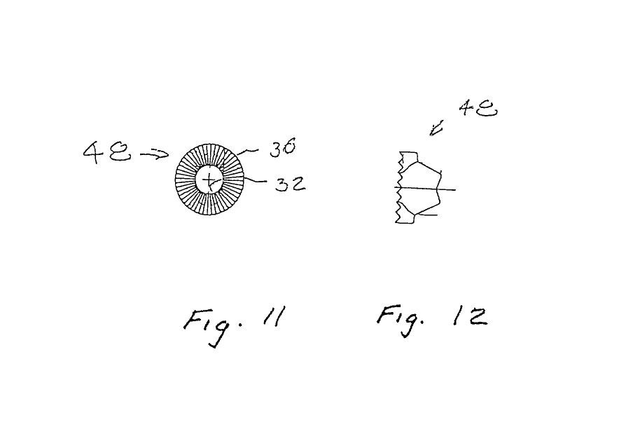

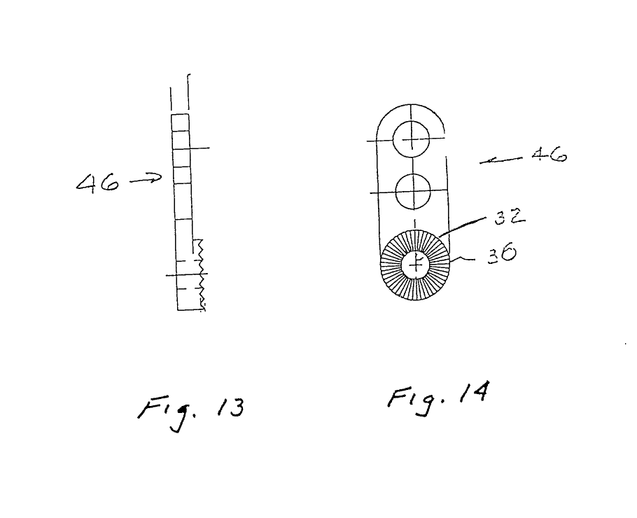

As best seen in FIG. 4, a rivet 42 extends through the side wall of the barrel 16 below (as viewed) the flange 19. The rivet 42 acts as a stop whereby as the eyebolt 18 is rotated counterclockwise, the flange 19 will abut the rivet 42 that is fixed to the barrel 16 and cause the barrel to move downwardly. In other words, rotating the eyebolt 18 counterclockwise will cause the jaw 30 to move away from the jaw 28. Ordinarily, the maximum travel downwardly of the eyebolt 18 with respect to the main body 12 is limited by the lip shaped stop 16a on the upper extremity of the barrel 16 interfering with the stop 14b on the elongated lower extremity 14. A major advantage of the clamp in accordance with the present invention is the ability to use a variety of modular connectors that are mounted on the mounting pad 36 to thereby provide exceptional versatility for the clamp in accordance with the present invention. FIGS. 5-15 illustrate representative types of modular connectors for use in the connection system in accordance with the present invention.

The ability to provide not merely an adapter for connecting to a tap line but alternatively to be used as a threaded stud adapter 41, a compression adapter 43, a stud adapter 44, a tapbolt connector adapter 48, a two hole connector adapter 46 or various other adapters together with the apparatus illustrated in FIGS. 1-4 will provide a connection system that is much more flexible than the related apparatus generally used previously.

While the present invention has been described in terms of a substantially round mounting pad 36 having a central opening or bore and a plurality of radially extending toothlike ridges 34 on a face which cooperates with a modular adapter having a substantially identical mounting pad 36 with radially extending ridges 34, it will be understood that other embodiments of the present invention may use various alternative complementary interfaces for attaching a modular accessory to the main body 12. For example, one mounting pad might have a single radially extending key or ridge extending intermediate, at least part of the distance between the geometric center of the mounting pad and the peripheral edge. The mating mounting pad could have a plurality of radially extending grooves disposed at intervals around at least a part of the face thereof. Such an arrangement retains installation flexibility (the ability to mount the accessory at any of a plurality of angles). Various other meshing constructions may be used to provide a structure that will not allow slippage even when a substantial load may be imposed on a tap line connecting to the accessory.

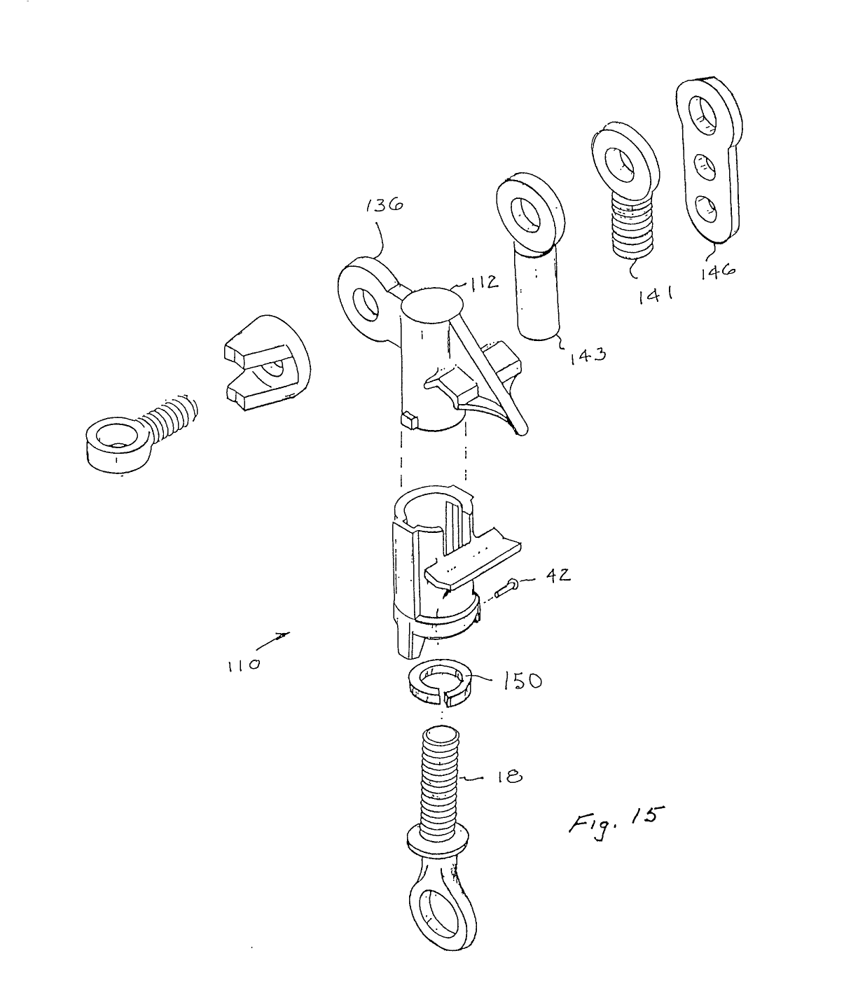

Although it is preferred to have a construction that resists any tendency to slip and which also provides flexibility as to the angular orientation, other embodiments may merely employ planar surface interfaces. One such embodiment is shown in the exploded view of FIG. 15. The hot line connector 110 illustrated therein is very similar to the hot line connector 10, however, this embodiment utilizes planar surface interfaces as best seen on adapters 141, 143, and 146 a planar surface mounting pad 156 to 136. A vanadium steel spring 150 which is preferably employed with all the disclosed hot line connectors compensates for the variable effects caused by fault currents, loads and atmospheric charges. The spring 150 also compensates for cold flow and differences in tightening torques.

Those skilled in the art will recognize that various other adapters may be utilized to achieve still greater versatility without the expense of manufacturing entire unique assemblies and without the expense of maintaining an inventory of entire unique assemblies in the marketing distribution channels or inventories of entire unique assemblies at the facilities of the consumer of this product.

Advantageously the vise-type design of the present invention provides a vibration proof connection on the run conductor. The invention provides extra wide jaws that provide optimum conductor contact, hold down the joint temperature, minimize conductor cold flow, and prevent the conductor from twisting during tightening. The duck bill extension 24 provides a guide for the installer to establish an initial contact with the run conductor. The invention may also use a mechanism that is spring-loaded with a rugged vanadium steel spring to compensate for the variables caused by full occurrence, loaded, and atmospheric changes. The spring-loaded feature also compensates for cold flow and offsets the varying tightening torques. Advantageously the connection is positioned to the side of the run conductor to prevent possible corrosion of the conductor or clamp on bimetal connections.

While preferred embodiments of the invention have been described, it should be appreciated that other modifications, adaptations and alternatives may occur to one skilled in the art without departing from the spirit and scope of the present invention.

What is claimed is:

1. A hot line clamp for attachment to an associated electrical distribution line which comprises:
a first body, said first body having a first jaw;
a second body, said second body having a second jaw, one of said first and second bodies having a screw thread disposed therein, and
an eyebolt dimensioned and configured for engaging said screw thread, said eyebolt having at least one surface engaging the other of said bodies to force the other of said bodies toward said one of said first and second bodies to cause said first and second jaws to clamp a received line conductor, one of said first and second bodies further including a first mounting pad for mounting at least one adapter for making an additional connection to said hot line clamp.

2. The hot line clamp in accordance with claim 1 wherein said first mounting pad includes non-planar surfaces to provide locking engagement.

3. The hot line clamp in accordance with claim 2 wherein said first mounting pad is circular and includes at least one ridge.

4. The hot line clamp in accordance with claim 3 wherein said clamp includes a modular accessory, said modular accessory including a second mounting pad that is complementary to said first mounting pad.

5. The hot line clamp in accordance with claim 4 wherein said first and second mounting pads provide locking engagement therebetween at any of a plurality of relative angular positions.

6. The hot line clamp in accordance with claim 3 wherein said first mounting pad includes a plurality of radially extending ridges.

7. The hot line clamp in accordance with claim 6 wherein said first mounting pad defines an opening and said plurality of radially extending ridges are disposed at equal angular intervals about said first opening pad.

8. The hot line clamp in accordance with claim 7 wherein said clamp includes a modular accessory, said modular accessory including a second mounting pad that is complementary to said first mounting pad, said first and second mounting pads being dimensioned and configured for meshing engagement.

9. The hot line clamp in accordance with claim 3 wherein said first mounting pad comprises an engagement interface which includes a plurality of radially extending ridges that are substantially uniformly disposed about the entire extent of said interface.

10. The hot line clamp in accordance with claim 9 wherein said clamp further includes an accessory having a second mounting pad dimensioned and configured for engagement with said first mounting pad.

11. The hot line clamp in accordance with claim 4 further including a tapbolt adapter dimensioned and configured for engagement with said second mounting pad.

12. The hot line clamp in accordance with claim 4 wherein said modular accessory comprises a stud adapter dimensioned and configured for the engagement with said first mounting pad.

13. A hot line clamp for attachment to an associated electrical distribution line which comprises:
a first body, said first body having a first jaw;
a second body, said second body having a second jaw, one of said first and second bodies having a screw thread disposed therein,
an eyebolt dimensioned and configured for engaging said screw thread, said eyebolt having at least one surface engaging the other of said bodies to force the other of said bodies toward said one of said first and second bodies to cause said first and second jaws to clamp a received associated line conductor, one of said first and second bodies further including a first means for mounting at least one adapter for making an additional connection to said hot line clamp.

14. The hot line clamp in accordance with claim 13 wherein said first mounting means includes non-planar surfaces to provide locking engagement with an adapter.

15. The hot line clamp in accordance with claim 13 wherein said first mounting means is circular and includes at least one ridge.

16. The hot line clamp in accordance with claim 15 wherein said clamp includes a modular accessory, said modular accessory including a second mounting means that is complementary to said first mounting means.

17. The hot line clamp in accordance with claim 4 wherein said first and second mounting pads include means for locking engagement therebetween at any of a plurality of relative angular positions.

18. The hot line clamp in accordance with claim 15 wherein said first mounting means comprises a plurality of radially extending ridges.

19. The hot line clamp in accordance with claim 18 wherein said first mounting means defines a central opening and said plurality of radially extending ridges are disposed at equal angular intervals about a central axis through said opening.

20. The hot line clamp in accordance with claim 19 wherein said clamp includes a modular accessory, said modular accessory including a second mounting means that is complementary to said first mounting means.

21. The hot line clamp in accordance with claim 1 wherein said first mounting pad includes non-planar surfaces to provide locking engagement.

22. The hot line clamp in accordance with claim 21 wherein said first mounting pad is circular.

23. The hot line clamp in accordance with claim 23 wherein said clamp includes a modular accessory, said modular accessory including a second mounting pad that is complementary to said first mounting pad.

24. The hot line clamp in accordance with claim 23 wherein said first mounting pad defines an opening and said plurality of radially extending ridges are disposed at equal angular intervals about said first opening pad.

25. The hot line clamp in accordance with claim 26 wherein said clamp includes a modular accessory, said modular accessory including a second mounting pad that is complementary to said first mounting pad, said first and second mounting pads being dimensioned and configured for meshing engagement.

26. The hot line clamp in accordance with claim 25 wherein said clamp further includes an accessory having a second mounting pad dimensioned and configured for engagement with said first mounting pad.

27. The hot line clamp in accordance with claim 22 further including a tapbolt adapter dimensioned and configured for engagement with said second mounting pad.

28. The hot line clamp in accordance with claim 22 wherein said modular accessory comprises a stud adapter dimensioned and configured for the engagement with said first mounting pad.

29. A hot line clamp for attachment to an associated electrical distribution line which comprises:
a first body, said first body having a first jaw;
a second body, said second body having a second jaw, one of said first and second bodies having a screw thread disposed therein,
an eyebolt dimensioned and configured for engaging said screw thread, said eyebolt having at least one surface engaging the other of said bodies to force the other of said bodies toward said one of said first and second bodies to cause said first and second jaws to clamp a received associated line conductor, one of said first and second bodies further including a first means for mounting at least one adapter for making an additional connection to said hot line clamp, said first mounting means includes planar surfaces for engagement with an adapter.

30. The hot line clamp in accordance with claim 29 wherein said first mounting means is circular and includes at least one ridge.

31. The hot line clamp in accordance with claim 30 wherein said clamp includes a modular accessory, said modular accessory including a second mounting means that is complementary to said first mounting means.
